(19) United States
(12) Patent Application Publication
(10) Pub. No.: US 2007/0041109 A1
(43) Pub. Date: Feb. 22, 2007

(54) Darkfield illumination system

(76) Inventors: Michael Brehm, Gottingen (DE); Ingo Fahlbusch, Goettingen (DE); Heino Heise, Adelebsen (DE); Werner Kleinschmidt, Adelebsen (DE); Anke Vogelsang, Goettingen (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/554,728

(22) PCT Filed: Mar. 10, 2004
(86) PCT No.: PCT/EP04/02432

§ 371 Date: Jun. 20, 2006

(30) Foreign Application Priority Data
Apr. 30, 2003 (DE) 103 20 529.2

(51) Int. Cl. G02B 5/08

(52) U.S. Cl. 359/857

(57) ABSTRACT

The invention is directed to a darkfield illumination system and is applicable in transmitted light microscopy and in incident light microscopy. A combination with a first, segmented mirror and a second, aspherical mirror is proposed for the purpose of uniform illumination of the large object fields occurring at low magnifications.

### CROSS-REFERENCE TO RELATED APPLICATIONS

This application claims priority of International Application No. PCT/EP2004/002432, filed Mar. 10, 2004, and German Application No. 103 20 529.2, filed Apr. 30, 2003, the complete disclosures of which are hereby incorporated by reference.

### BACKGROUND OF THE INVENTION

a) Field of the Invention

The invention is directed to a darkfield illumination system and is applicable in transmitted light microscopy and in incident light microscopy.

b) Description of the Related Art

It is known to realize darkfield illumination in optical light microscopes in different ways:
through the use of annular diaphragms in the entrance-side condenser pupil
plane mirror arrangements constructed as light steps (e.g., JP 10268205)
annularly arranged toroidal micromirrors (e.g., JP 11153755)
a combination of concave and convex annular mirrors (e.g., DR 830 840, DE 24 10 874).

All of these solutions have in common that they can only illuminate small object fields, i.e., they are only suitable for high magnifications (greater than 10×).

In order to illuminate larger object fields also, DE 34 25 674 proposes the use of an annular mirror constructed as a special toroid. This solution also has adequate quality only up to a magnification of 10×. The illumination is so inhomogeneous for larger object fields that an additional diffusing screen must be used for homogenization, which worsens light efficiency appreciably.

A condenser in which partial mirror surfaces which are arranged in a pyramid shape relative to one another are used as principal mirror and complementary mirror is described in DR 608 644 from the year 1935. On principle, this solution also has inhomogeneous illumination; further, in particular, the construction of the concave mirror as a segmented mirror is difficult to realize with the required accuracy.

Further, special solutions are known for low magnifications such as the mirror step with three mirror surfaces which is realized in the 2.5x HD-Epiplan-Neofluar by Zeiss, wherein one of these mirror surfaces also has stamped toroidal micromirrors.

### OBJECT AND SUMMARY OF THE INVENTION

It is the primary object of the invention to overcome the disadvantages of the prior art and to provide a darkfield illumination which also uniformly illuminates large object fields (e.g., at 2.5× magnification).

In accordance with the invention, a darkfield illumination system comprises a first annular mirror and a second annular mirror, wherein an illumination beam bundle impinging on the first annular mirror is reflected to the second annular mirror and is reflected by the latter to an object plane. The first annular mirror is a segmented mirror and formed of partial plane mirrors. The second annular mirror is formed as an aspherical mirror.

According to the invention, the annular mirror facing the light source is formed of individual plane mirror segments and the object-side annular mirror is constructed as an aspherical mirror. Accordingly, both the sagittal rays and the meridional rays are distributed over the object field with very high uniformity.

It is advantageous when the number of plane mirror segments is greater than 5, and is preferably greater than 10.

The aspherical mirror advantageously satisfies the following section equation:

$$z = \frac{\frac{{( \vert h \vert + {h}_{0} )}^{2}}{r}}{1 + \sqrt{1 - \frac{{( \vert h \vert + {h}_{0} )}^{2}}{{r}^{2}}}} ,$$

where z is the sagitta, h²=x²+y² is the distance from the optical axis that coincides with the z-axis, and h₀ and r are constants. In this connection, ho is the displacement of the meridional center of curvature of the optical axis, r is the meridional radius of curvature. By means of the inventive teaching indicated herein, a condenser for darkfield illumination and an incident light illumination can both be realized. By appropriate selection of the constants, it is also possible to achieve greater working distances and, in spite of this, a homogeneous illumination.

### BRIEF DESCRIPTION OF THE DRAWINGS

In the drawings:

The invention will be described in the following with reference to FIGS. 1 to 7.

FIG. 1 shows a basic diagram of a darkfield illumination system according to the invention (with rays in the meridional section);

FIG. 2 shows a basic diagram of a darkfield illumination system according to the invention (with rays in the sagittal section);

FIG. 3 shows a prior art solution for a 2.5× objective with three reflections;

FIG. 4 shows a darkfield illumination system, according to the invention, at an objective for incident illumination;

FIG. 5 shows a darkfield illumination system, according to the invention, as a slider for a condenser, in section;

FIG. 6 shows a darkfield illumination system, according to the invention, as a slider for a condenser, in a three-dimensional view; and

FIG. 7 shows a transmitted light condenser by way of example for using the slider according to FIGS. 5 and 6.

### DESCRIPTION OF THE PREFERRED EMBODIMENTS

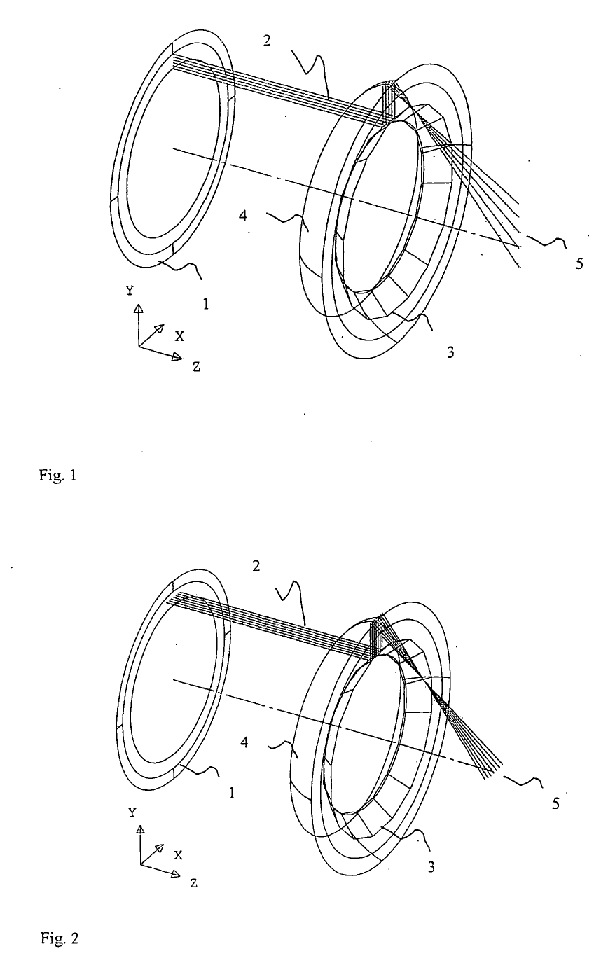

FIG. 1 shows a three-dimensional view of a darkfield illumination system according to the invention. The meridional rays 2 coming from the light source 1, shown schematically, are reflected at the segment mirror 3 outwardly on the aspherical mirror 4. The latter focuses the rays on a point between the mirror and the object. The light rays are subsequently scattered again uniformly over the entire object field 5.

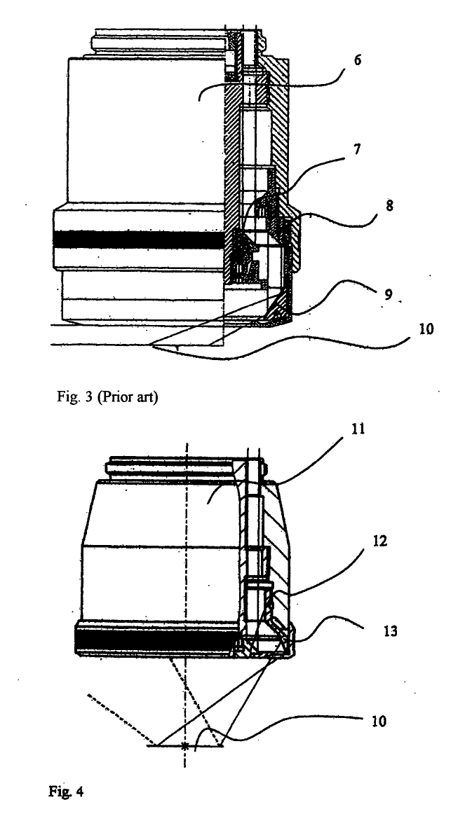

A uniform illumination is likewise achieved with the sagittal rays shown in FIG. 2 (identical reference numbers are used for identical elements). The known solution shown in FIG. 3 for a 2.5× objective 6 has a darkfield illumination channel with three reflections at truncated-cone mirrors 7, 8 and 9. The light reflected by the mirror 9 illuminates the object field 10, wherein only small working distances can be achieved based on the principle.

FIG. 4 shows the realization of the invention in a novel 2.5× objective 11. The darkfield illumination channel has a first, segmented mirror 12 and an aspherical mirror 13. The light rays reflected by the mirror 13 illuminate the object field 10 uniformly, wherein greater working distances than those in the solutions according to the prior art can also be realized.

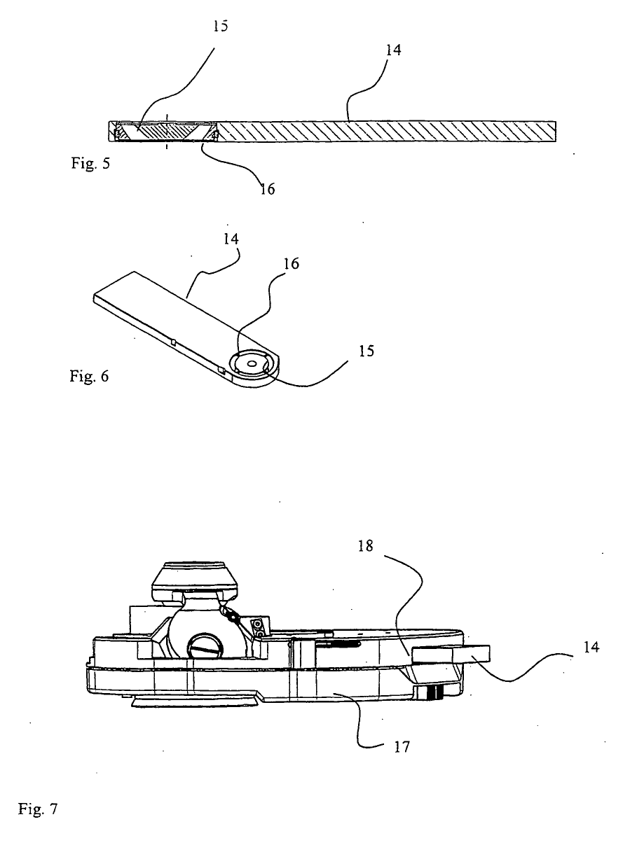

In FIGS. 5 and 6, the slider 14 has a cutout containing a segmented mirror 15 and an aspherical mirror 16.

FIG. 7 shows how the slider 14 can be arranged in a condenser 17 for transmitted light illumination. For this purpose, the condenser 17 has a cutout 18 in which the slider 14 is inserted and, accordingly, the mirrors 15, 16 can be introduced into the beam path of the microscope.

The following table shows preferred values for the constants h₀ and r and the resulting values for the working distance:

| Angle of | Quantity of | | | Working |
|---|---|---|---|---|
| segmented mirror | segments | r | h₀ | distance |
| 45° | 16 | −10.0 mm | −7.5 mm | 15 mm |
| 45° | 8 | −23.8 mm | +6.5 mm | 34 mm |

The realization of the invention is not limited to the embodiment examples shown herein. Further developments by persons skilled in the art are not to be understood as deviating from the essence and scope of the present invention.

While the foregoing description and drawings represent the present invention, it will be obvious to those skilled in the art that various changes may be made therein without departing from the true spirit and scope of the present invention.

1-5. (canceled)

6. A darkfield illumination system comprising:
a first annular mirror;
a second annular mirror;
wherein an illumination beam bundle impinging on the first annular mirror is reflected to the second annular mirror and is reflected by the latter to an object plane;
said first annular mirror being a segmented mirror and formed of plane partial mirrors; and
said second annular mirror being formed as an aspherical mirror.

7. The darkfield illumination system according to claim 6, wherein the segmented mirror comprises a quantity of segments whose quantity is preferably greater than 5.

8. The darkfield illumination system according to claim 6, wherein the aspherical mirror satisfies the following section equation:
$$z = \frac{\frac{{( \vert h \vert + {h}_{0} )}^{2}}{r}}{1 + \sqrt{1 - \frac{{( \vert h \vert + {h}_{0} )}^{2}}{{r}^{2}}}} ,$$
where z is the sagitta, h2=x2+y2 is the distance from the optical axis, and h0 and r are constants.

9. A condenser for transmitted-light darkfield illumination with a darkfield illumination system according to claim 6.

10. A method for using a darkfield illumination with a darkfield illumination system according to claim 6, comprising the step of using said system for incident-light darkfield illumination.
